(19) United States
(12) Patent Application Publication
(10) Pub. No.: US 2025/0158092 A1
(43) Pub. Date: May 15, 2025

(54) AIR-COOLED FUEL CELL SYSTEM AND METHOD FOR OPERATING SAME

(71) Applicant: ZeroAvia, Inc., Hollister, CA (US)

(72) Inventors: Sergei Shubenkov, Moscow (RU); Sergei Panov, Rybinsk (RU); Aleksey Ivanenko, Zvenigorod (RU); Alexander Todorov, Moscow (RU); Ilya Kosarev, Dolgoprudniy (RU); Brian Benicewicz, Columbia, SC (US); Rhonda Staudt, Niskayuna, NY (US); John Anthony Vogel, Charlton, NY (US)

(73) Assignee: ZeroAvia, Inc., Hollister, CA (US)

(21) Appl. No.: 18/838,203

(22) PCT Filed: Feb. 16, 2022
(86) PCT No.: PCT/US2022/016602

§ 371 Date: Aug. 13, 2024

(51) Int. Cl. H01M 8/04014; H01M 8/04007; H01M 8/04111; H01M 8/04119; H01M 8/0612; H01M 8/0662; H01M 8/10

(52) U.S. Cl. CPC H01M 8/04022; H01M 8/04059; H01M 8/04111; H01M 8/04126; H01M 8/0612; H01M 8/0662; H01M 2008/1095

(57) ABSTRACT

The invention relates to air-cooled fuel cell systems, in particular to mid-and high temperature fuel cells with operating temperatures ranging from 100 to 1.000° C. and to methods for operating an air-cooled fuel cell system. The air-cooled fuel cell system comprising at least one fuel cell stack (1) with a gaseous heat carrier distribution system (2), an anode gas distribution system (3) and a cathode gas distribution system (4); a burner (14); an expander (9; 24); a motor; a compressor (8; 23); a gaseous heat carrier recirculation system (5) connected to the gaseous heat carrier distribution system (2) and intended for mixing a gas stream delivered to the gaseous heat carrier distribution system and providing additional pressure thereto, and means for separating gas streams and controlling their flowrate. The technical effect improves reliability and operating efficiency of a fuel cell in any climatic conditions and in a broad range of aviation altitudes.

### FIELD OF THE INVENTION

The proposed invention relates to air-cooled fuel cell systems, in particular to mid-and high-temperature fuel cells with operating temperatures ranging from 100 to 1,000° C., and to methods for operating an air-cooled fuel cell system.

The invention is suitable both for stationary fuel cell systems and for fuel cell plants intended for operation of vehicles, in particular aircraft used in a wide altitude range.

### DESCRIPTION OF PRIOR ART

Fuel cells are electrochemical devices that may convert chemical energy of a fuel to electric energy with high efficiency.

U.S. Pat. No. 3,972,731, published on Aug. 3, 1976, discloses a fuel cell power plant comprising a fuel cell stack having an anode and a cathode. A cathode effluent gas stream is delivered to a burner for being heated and then enters an expander which drives a compressor that is arranged on the common shaft with the expander and is intended for delivering air to the cathode. A cathode effluent gas stream is cooled and dried when passed through a heat-exchanger before being supplied to a burner. Another heat-exchanger and circulating coolant is used for cooling a fuel cell. An anode effluent gas stream is delivered to another burner to provide heat for a steam reforming reactor. Then, the anode effluent gas stream is used for superheating steam leaving a boiler.

Disadvantages of this invention are complexity and high weight of its structure due to use of multiple heat-exchangers, which negatively affects reliability, specific power and efficiency of the cells.

U.S. Pat. No. 6,632,551 B1, published on Oct. 14, 2003, discloses a fuel cell system comprising an arrangement of fuel cell with an anode and a cathode. A hydrogen-rich medium is fed into a reformer, then it is lead into a carbon monoxide removal unit and fed as a hydrogen-rich reformate to an anode of a fuel cell. An anode off-gas and a cathode off-gas are mixed in a mixer and fed into a catalytic burner wherein a metered supply of a combustible material comprising hydrogen, e.g. methanol, petrol, or methane, is delivered. The off-gas streams are heated to 450-900° C. in the catalytic burner and are fed to an expander driving a compressor, which delivers air at a high pressure to the cathode. From the expander, the off-gas streams, as cooled by 50-200° C., are fed to a heating chamber of a reforming unit to support an endothermic reforming reaction. An evaporator or a heat exchanger may be used instead of the reforming unit.

A disadvantage of this invention is absence of the possibility of preheating a fuel cell and controlling temperature gradients in the fuel cell arrangement, which negatively affects reliability and efficiency of the cells, since, in this case, their operability depends on ambient temperature. So, additional temperature control subsystem is required for a fuel cell system balancing.

U.S. Pat. No. 4,041,210 A, published on Aug. 9, 1977, discloses a fuel cell system comprising a fuel cell stack with an anode and a cathode. A hydrogen containing gas enters a fuel processing apparatus and then is fed to the fuel cell anode. One cathode gas effluent stream enters an expander which drives a compressor that is arranged on the common shaft with the expander and feeds air at a high pressure to a catalytic burner; and a second stream is cooled and recirculated. The anode effluent gas stream is mixed with air in the catalytic burner. After leaving the burner, this stream is mixed with recirculated gases effluent from the cathode and is delivered to the cathode.

A disadvantage of this invention is absence, in the framework of this system, the possibility of preheating and cooling a fuel cell, which means a more complex system comprising a greater number of components in its real implementation, including a temperature control sub-system. And this means that the system is less reliable and less effective. Further, in this solution, an anode effluent gas stream heated in the catalytic burner is delivered directly to the cathode, and cathode air with added burner effluent gases and air is recirculated, which leads to reduction of oxygen partial pressure (i.e. to oxygen depletion) in the air delivered to the cathode and to lowering a fuel cell capacity.

U.S. Pat. No. 6,887,609 B2, published on May 3, 2005, discloses a system based on low-temperature polymer electrolyte membrane (PEM) fuel cells, which comprises a fuel cell unit with an anode and a cathode, a hydrogen flow path for the anode, an air flow path for the cathode, an anode exhaust-flow path and a cathode exhaust-flow path. The anode and cathode exhaust gas flows are fed to a catalytic burner either separately, or being preliminarily mixed. In the catalytic burner, the exhaust-gas flows are heated to 150-1,100° C. and then are delivered to an expander that drives a compressor arranged in the air flow path for the cathode. The expander and the compressor are preferably arranged on a common shaft.

A disadvantage of this system is that it is not integrated with a fuel cell thermal control system, and, consequently, the possibility of using its components for preheating and cooling a fuel cell and controlling temperature gradients in the fuel cell unit is absent, which means that a complete system implemented on the basis of this invention will be more complex and will comprise a greater number of components, so it will be “heavier” and its reliability and efficiency will be affected negatively. Moreover, this system may not be operated independently, since it lacks a fuel cell thermal control system.

### SUMMARY OF THE INVENTION

The objects of the present invention are to overcome shortcomings of known technical solutions, improve reliability and operating efficiency of a fuel cell-based system intended for producing electrical energy, reduce a weight of such a fuel cell system, while preserving the possibility of providing effective thermal control of a fuel cell, which will enable to use such a fuel cell in any climatic conditions and at any altitudes, what is especially important in operation of aircraft where a weight of a fuel cell system is of great value.

The technical effect of the claimed invention is improvement in reliability and operating efficiency of a fuel cell-based system intended for producing electrical energy, reduction of a weight of such a fuel cell system, while preserving the possibility of providing effective thermal control of a fuel cell, which will enable to use such a fuel cell in any climatic conditions and in a broad range of altitudes, in particular in aviation.

To reach the above object and achieve the technical effect, a method for operating an air-cooled fuel cell system is proposed, the system comprising:
at least one fuel cell stack with a gaseous heat carrier distribution system, an anode gas distribution system and a cathode gas distribution system;
a burner;
an expander;
a motor;
a compressor;
a gaseous heat carrier recirculation system connected to the gaseous heat carrier distribution system of said at least one fuel cell stack and intended for mixing a gas stream delivered to the gaseous heat carrier distribution system and providing additional pressure thereto, and
means for separating gas streams and controlling their flowrate;

the method comprising the following processes:
(a) feeding an A1 gaseous fuel stream to the anode gas distribution system of said at least one fuel cell stack,
feeding a B1 oxygen-containing mixture stream to the cathode gas distribution system of said at least one fuel cell stack, the pressurized B1 stream being delivered by a compressor driven by the expander and the motor, and
feeding a B2 oxygen-containing mixture stream to the gaseous heat carrier recirculation system;
(b) withdrawing, from said at least one fuel cell stack, a C stream of gases effluent from the anode gas distribution system, a D stream of gases effluent from the cathode gas distribution system, and an F stream of gases effluent from the gaseous heat carrier distribution system;
(c) feeding the C stream and the D stream to the burner;
(d) feeding an E stream of gases outgoing from the burner to the expander, after which the E stream is separated into two streams: E1 and E2,
discharging the E1 stream to the atmosphere, and
feeding the E2 stream to the gaseous heat carrier recirculation system;
(e) separating the F stream into two streams: F1 and F2,
discharging the F1 stream to the atmosphere, and
feeding the F2 stream to the gaseous heat carrier recirculation system, where it is mixed with the B2 stream and with the E2 stream for producing a mixed stream that is fed to the gaseous heat carrier distribution system.

Owing to feeding of the A1 and B1 streams to the fuel cell stack, it produces electrical and thermal power.

In the burner, the D stream is heated owing to fact that oxygen contained therein oxidizes the C gaseous fuel stream.

Mixing of the hot (F2 and E2) and cold (B2) streams in various ratios enables to control a temperature of a mixed stream fed to the fuel cell stack for cooling it.

Preferably, before conducting the (a)-(e) processes, a step of preheating said at least one fuel cell stack to a preset temperature is performed, the step comprising the following processes:
feeding the B1 oxygen-containing mixture stream and an A2 gaseous fuel stream to the burner, the pressurized B1 stream being delivered by the compressor driven by the expander and the motor;
feeding the E stream of gases outgoing from the burner to the expander with subsequent feeding of the E stream to the gaseous heat carrier distribution system, and
discharging the F stream of gases effluent from the gaseous heat carrier distribution system to the atmosphere.

In the gaseous heat carrier distribution system, heat exchange takes place between the gaseous heat carrier and the fuel cell stack:
in the preheating step, the E stream of gases outgoing from the burner, while passing through the gaseous heat carrier distribution system, transfers heat to the fuel cell stack, thus heating it to a preset temperature;
during the (a)-(e) processes, a mixed stream, while passing through the gaseous heat carrier distribution system, withdraws heat from the fuel cell stack, thus cooling it.

Preferably, hydrogen or synthesis gas is used as the gaseous fuel, and pure oxygen, atmospheric air, mixture of oxygen and water steam, or another mixture of oxygen and gases not involved in the electrochemical reaction is used as the oxygen-containing mixture.

Preferably, the burner is a catalytic burner.

To reach the above object and achieve the technical effect, a method for operating an air-cooled fuel cell system is also proposed, the system comprising:
at least one fuel cell stack with a gaseous heat carrier distribution system, an anode gas distribution system and a cathode gas distribution system;
a burner;
an expander;
a motor;
a compressor;
an additional expander;
an additional motor;
an additional compressor; and
means for separating gas streams and controlling their flowrate;
the method comprising the following processes:
(a) feeding an A1 gaseous fuel stream to the anode gas distribution system,
feeding a B oxygen-containing mixture stream to the additional compressor driven by the additional expander and the additional motor, and subsequently separating the B stream into a B1 stream and a B2 stream,
feeding the B1 stream to the cathode gas distribution system, the pressurized B1 stream being delivered by the compressor driven by the expander and the motor, and
feeding the B2 stream to the gaseous heat carrier distribution system;
(b) withdrawing, from said at least one fuel cell stack, a C stream of gases effluent from the anode gas distribution system, a D stream of gases effluent from the cathode gas distribution system, and an F stream of gases effluent from the gaseous heat carrier distribution system,
(c) feeding the C stream and the D stream to the burner,
(d) feeding an E stream of gases outgoing from the burner to the expander, after which the E stream is separated into two streams: E1 and E2,
mixing the E1 stream and an F stream and, subsequently, feeding the mixture to the additional expander with the subsequent discharge of it to the atmosphere, and
mixing the E2 stream and the B2 stream to produce a mixed stream that is fed to the gaseous heat carrier distribution system,
(e) feeding the F stream of gases effluent from the gaseous heat carrier distribution system to the additional expander with subsequent discharge to the atmosphere.

Owing to feeding the A1 and B1 streams to the fuel cell stack, it produces electrical and thermal power.

In the burner, the D stream of the oxygen-containing mixture is heated owing to the fact that oxygen contained therein oxidizes the C gaseous fuel stream.

A mixed stream temperature is controlled by a volume flowrate of E2 stream (hot) and a ratio of the B stream compression in the additional compressor.

Preferably, before conducting the (a)-(e) processes, a step of preheating of said at least one fuel cell stack to a preset temperature is performed, the step including the following processes:
feeding the B oxygen-containing mixture stream and the A2 gaseous fuel stream to the burner, the pressurized B stream being delivered by the compressor driven by the expander and the motor and the additional compressor driven by the additional expander and the additional motor,
feeding the E stream of gases outgoing from the burner to the expander and subsequently feeding the E stream to the gaseous heat carrier distribution system, and
feeding the F stream of gases effluent from the gaseous heat carrier distribution system to the additional expander and subsequently discharging the F stream to the atmosphere.

In the gaseous heat carrier distribution system, heat exchange takes place between the gaseous heat carrier and the fuel cell stack:
in the preheating step, the E stream of gases outgoing from the burner, while passing through the gaseous heat carrier distribution system, transfers heat to the fuel cell stack, thus heating it to a preset temperature,
during the (a)-(e) processes, a mixed stream, while passing through the gaseous heat carrier distribution system, withdraws heat from the fuel cell stack, thus cooling it.

Preferably, hydrogen or synthesis gas is used as the gaseous fuel, and atmospheric air, mixture of oxygen and water steam, or another mixture of oxygen and gases not involved in the electrochemical reaction is used as the oxygen-containing mixture.

Preferably, the burner is a catalytic burner.

To reach the above object and achieve the technical effect, a method for operating an air-cooled fuel cell system is also proposed, the system comprising:
at least one fuel cell stack with a gaseous heat carrier distribution system, an anode gas distribution system and a cathode gas distribution system,
a burner,
an expander,
a motor,
a compressor,
an additional expander,
an additional motor,
an additional compressor,
a gaseous heat carrier recirculation system connected to a gaseous heat carrier distribution system of the fuel cell stack and intended for mixing a gas stream delivered to the gaseous heat carrier distribution system and providing additional pressure thereto, and
means for separating gas streams and controlling their flowrate,
the method comprising the following processes:
(a) feeding an A1 gaseous fuel stream to the anode gas distribution system,
feeding a B oxygen-containing mixture stream to the additional compressor driven by the additional expander and the additional motor, and subsequently separating the B stream into a B1 stream and a B2 stream,
feeding the B1 stream to the cathode gas distribution system, the pressurized B1 stream being delivered by the compressor driven by the expander and the motor, and
feeding the B2 stream to the gaseous heat carrier recirculation system,
(b) withdrawing, from said at least one fuel cell stack, a C stream of gases effluent from the anode gas distribution system, a D stream of gases effluent from the cathode gas distribution system, and an F stream of gases effluent from the gaseous heat carrier distribution system;
(c) feeding the C stream and the D stream to the burner;
(d) feeding an E stream of gases outgoing from the burner to the expander, after which the E stream is separated into two streams: E1 and E2;
feeding the E1 stream to the additional expander with subsequent discharge to the atmosphere, and
feeding the E2 stream to the gaseous heat carrier recirculation system;
(e) separating the F stream into two streams: F1 and F2,
feeding the F1 stream to the additional expander and subsequently discharging the F1 stream to the atmosphere, and
feeding the F2 stream to the gaseous heat carrier recirculation system where it is mixed with the B2 stream and with the E2 stream to produce a mixed stream that is fed to the gaseous heat carrier distribution system.

Owing to feeding the A1 and B1 streams to the fuel cell stack, it produces electrical and thermal power.

In the burner, the D oxygen-containing mixture stream is heated owing to the fact that oxygen contained therein oxidizes the C gaseous fuel stream.

Mixing of the hot (F2 and E2) and cold (B2) streams in various ratios enables to control a temperature of a mixed stream fed to the fuel cell stack for cooling it.

Additionally, a mixed stream temperature is controlled by a compression ratio of the B stream in the additional compressor.

Preferably, before conducting the (a)-(e) processes, a step of preheating of said at least one fuel cell stack to a preset temperature is performed, the step including the following processes:
feeding the B oxygen-containing mixture stream and the A2 gaseous fuel stream to the burner, the pressurized B stream being delivered by the compressor driven by the expander and the motor and the additional compressor driven by the additional expander and the additional motor,
feeding the E stream of gases outgoing from the burner to the expander and subsequently
feeding the E stream to the gaseous heat carrier distribution system, and
feeding the F stream of gases effluent from the gaseous heat carrier distribution system to the additional expander and subsequently discharging the F stream to the atmosphere.

Preferably, hydrogen or synthesis gas is used as the gaseous fuel; and atmospheric air, mixture of oxygen and water steam, or another mixture of oxygen and gases not involved in the electrochemical reaction is used as the oxygen-containing mixture.

Preferably, the burner is a catalytic burner.

To reach the above object and achieve the technical effect, an air-cooled fuel cell system is also proposed, the system comprising:
at least one fuel cell stack with a gaseous heat carrier distribution system, an anode gas distribution system and a cathode gas distribution system,
a gaseous heat carrier recirculation system connected to the gaseous heat carrier distribution system and intended for mixing a gas stream delivered to the gaseous heat carrier distribution system and providing additional pressure thereto,
a conduit for feeding an A1 gaseous fuel stream to the anode gas distribution system,
a conduit for feeding a B1 stream to the cathode gas distribution system,
a compressor for delivering a pressurized B1 oxygen-containing mixture stream, which is configured to be driven by an expander and a motor,
a conduit for feeding a B2 oxygen-containing mixture stream to the gaseous heat carrier recirculation system,
a conduit for withdrawing a C stream of gases effluent from the anode gas distribution system,
a conduit for withdrawing a D stream of gases effluent from the cathode gas distribution system,
a conduit for withdrawing an F stream of gases effluent from the gaseous heat carrier distribution system,
a burner provided with a conduit for feeding an A2 gaseous fuel stream thereto and a conduit for withdrawing an E stream of gases outgoing therefrom,
means for separating gas streams and controlling their flowrate,
wherein
the burner is connected to the conduit for withdrawing a C stream of gases effluent from the anode gas distribution system and the conduit for withdrawing a D stream of gases effluent from the cathode gas distribution system, so that the C stream of gases effluent from the anode gas distribution system and the D stream of gases effluent from the cathode gas distribution system enter the burner,
the conduit for withdrawing the E stream of gases outgoing from the burner is configured to feed the E stream of gases outgoing from the burner first to an expander at which outlet this conduit is divided into a conduit for withdrawing an E1 stream and a conduit for withdrawing an E2 stream, which are made so that the E1 stream is discharged to the atmosphere, and the E2 stream enters the gaseous heat carrier recirculation system,
and wherein
the conduit for withdrawing the F stream of gases effluent from the gaseous heat carrier distribution system is divided into a conduit for withdrawing an F1 stream and a conduit for withdrawing an F2 stream, which are made so that the F1 stream is discharged to the atmosphere, and the F2 stream enters the gaseous heat carrier recirculation system, where it is mixed with the B2 oxygen-containing mixture stream and the E2 stream to produce a mixed stream that is fed to the gaseous heat carrier distribution system.

To reach the above object and achieve the technical effect, an air-cooled fuel cell system is also proposed, the system comprising:
at least one fuel cell stack with a gaseous heat carrier distribution system, an anode gas distribution system and a cathode gas distribution system,
a conduit for feeding an A1 gaseous fuel stream to the anode gas distribution system conduit,
a conduit for feeding a B oxygen-containing mixture stream, which is divided into a conduit for feeding a B1 stream to the cathode gas distribution system and a conduit for feeding a B2 stream to the gaseous heat carrier distribution system,
a compressor for delivering a pressurized B1 oxygen-containing mixture stream, which is configured to be driven by an expander and a motor,
an additional compressor for delivering a pressurized B oxygen-containing mixture stream, which is configured to be driven by an additional expander and an additional motor,
a conduit for withdrawing a C stream of gases effluent from the anode gas distribution system,
a conduit for withdrawing a D stream of gases effluent from the cathode gas distribution system,
a conduit for withdrawing an F stream of gases effluent from the gaseous heat carrier distribution system,
a burner provided with a conduit for feeding an A2 gaseous fuel stream thereto and a conduit for withdrawing an E stream of gases outgoing from the burner,
means for separating gas streams and controlling their flowrate,
wherein
the burner is connected to the conduit for withdrawing the C stream of gases effluent from the anode gas distribution system and the conduit for withdrawing the D stream of gases effluent from the cathode gas distribution system, so that the C stream of gases effluent from the anode gas distribution system and the D stream of gases effluent from the cathode gas distribution system enter the burner,
a conduit for withdrawing the E stream of gases outgoing from the burner is configured to feed the E stream of gases outgoing from the burner first to an expander at the outlet of which this conduit is divided into a conduit for withdrawing an E1 stream and a conduit for withdrawing an E2 stream, these conduits being made so that the E1 stream enters an additional expander and further to the atmosphere, and the E2 stream is mixed with the B2 stream to produce a mixed stream that is fed to the gaseous heat carrier distribution system,
and wherein
the conduit for withdrawing the F stream is made so that the F stream enters to the additional expander and further to the atmosphere.

To reach the above object and achieve the technical effect, an air-cooled fuel cell system is also proposed, the system comprising:
at least one fuel cell stack with a gaseous heat carrier distribution system, an anode gas distribution system and a cathode gas distribution system,
a gaseous heat carrier recirculation system connected to the gaseous heat carrier distribution system of said fuel cell stack and intended for mixing a gas stream entering the gaseous heat carrier distribution system and providing additional pressure thereto,
a conduit for feeding an A1 gaseous fuel stream to the anode gas distribution system,
a conduit for feeding a B oxygen-containing mixture stream, which is divided into a conduit for feeding a B1 stream to the cathode gas distribution system and a conduit for feeding a B2 stream to the gaseous heat carrier recirculation system,
a compressor for delivering the pressurized B1 oxygen-containing mixture stream, which is configured to be driven by an expander and a motor,
an additional compressor for delivering the pressurized B oxygen-containing mixture stream, which is configured to be driven by an additional expander and an additional motor,
a conduit for withdrawing a C stream of gases effluent from the anode gas distribution system,
a conduit for withdrawing a D stream of gases effluent from the cathode gas distribution system.
a conduit for withdrawing an F stream of gases effluent from the gaseous heat carrier distribution system,
a burner provided with a conduit for feeding an A2 gaseous fuel stream thereto and a conduit for withdrawing an E stream of gases outgoing from the burner,
means for separating gas streams and controlling their flowrate,
wherein
the burner is connected to the conduit for withdrawing the C stream of gases effluent from the anode gas distribution system and the conduit for withdrawing the D stream of gases effluent from the cathode gas distribution system, so that the C stream of gases effluent from the anode gas distribution system and the D stream of gases effluent from the cathode gas distribution system enter the burner,
a conduit for withdrawing the E stream of gases outgoing from the burner is configured to feed the E stream of gases outgoing from the burner first to an expander at the outlet of which this conduit is divided into a conduit for withdrawing an E1 stream and a conduit for withdrawing an E2 stream, these conduits being made so that the E1 stream enters an additional expander and further to the atmosphere, and the E2 stream is mixed with the B2 stream to produce a mixed stream that is fed to the gaseous heat carrier distribution system,
and wherein
the conduit for withdrawing the F stream of gases effluent from the gaseous heat carrier distribution system is divided into a conduit for withdrawing an F1 stream and a conduit for withdrawing an F2 stream, which are made so that the F1 stream enters to the additional expander and further is discharged to the atmosphere, and the F2 stream enters the gaseous heat carrier recirculation system, where it is mixed with the B2 oxygen-containing mixture stream and the E2 stream to produce a mixed stream that is fed to the gaseous heat carrier distribution system.

### BRIEF DESCRIPTION OF THE DRAWINGS

The accompanying drawings are presented to provide better understanding of the present invention, but it will be obvious for a person skilled in the art that the disclosed invention is not limited by the embodiments shown therein.

FIG. 1 shows a schematic view of an air-cooled fuel cell system according to Embodiment 1 of the present invention.

FIG. 2 shows a schematic view of an air-cooled fuel cell system according to Embodiment 2 of the present invention.

FIG. 3 shows a schematic view of an air-cooled fuel cell system according to Embodiment 3 of the present invention.

FIG. 4 shows a comparison diagram of the component weights of the fuel cell system according to Embodiment 1 of the present invention and the component weights of a conventional liquid-cooled fuel cell system.

FIG. 5 shows a comparison diagram of the component weights of the fuel cell system according to Embodiment 2 of the present invention and the component weights of a conventional liquid-cooled fuel cell system for high altitude operation.

FIG. 6 shows a comparison diagram of the component weights of the fuel cell system according to Embodiment 3 of the present invention and the component weights of a conventional liquid-cooled fuel cell system universal for wide range of altitudes operation.

In the drawings, a solid line shows the main circulation loop of an oxygen-containing mixture, a fuel and off-gases, and a broken line shows the circulation loop of an oxygen-containing mixture, a fuel and off-gases in the fuel cell preheating step. The dotted line shows electric power supply from the fuel cell stack and a startup battery to electric motors.

### DESCRIPTION OF PREFERRED EMBODIMENTS OF THE INVENTION

### Embodiment 1

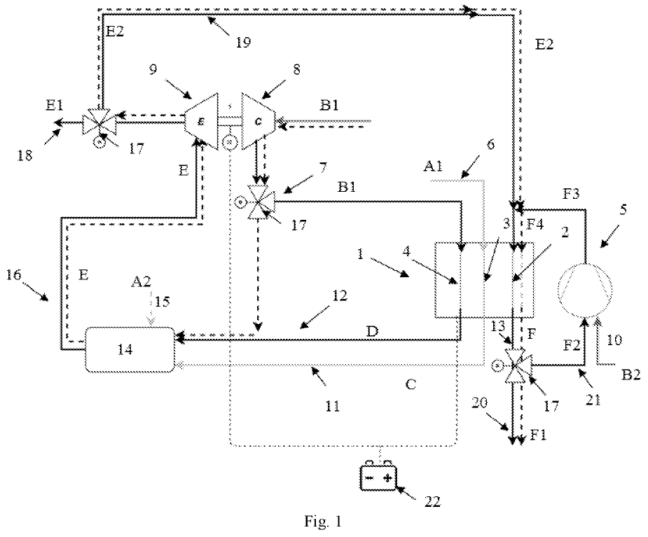

FIG. 1 shows an air-cooled fuel cell system comprising a fuel cell stack 1.

The fuel cell stack 1 comprises a gaseous heat carrier distribution system 2, an anode gas distribution system 3 and a cathode gas distribution system 4.

The gaseous heat carrier distribution system 2, the anode gas distribution system 3 and the cathode gas distribution system 4 represent any systems known in the art that comprise means for distribution of gaseous media, e.g. channels, recesses and hollows enabling to pass gases to individual fuel cells in a fuel cell stack.

The air-cooled fuel cell system further comprises a gaseous heat carrier recirculation system 5 connected to the gaseous heat carrier distribution system 2 and intended for mixing a gas stream entering the gaseous heat carrier distribution system 2 and providing additional pressure thereto.

Furthermore, the air-cooled fuel cell system comprises:
a conduit 6 for feeding an Al gaseous fuel stream to the anode gas distribution system 3,
a conduit 7 for feeding a BI stream to the cathode gas distribution system 4,
a compressor 8 for delivering the pressurized BI oxygen-containing mixture stream, which is configured to be driven by an expander 9 and a motor (not shown),
a conduit 10 for feeding a B2 oxygen-containing mixture stream to the gaseous heat carrier recirculation system 5,
a conduit 11 for withdrawing a C stream of gases effluent from the anode gas distribution system 3,
a conduit 12 for withdrawing a D stream of gases effluent from the cathode gas distribution system 4,
a conduit 13 for withdrawing an F stream of gases effluent from the gaseous heat carrier distribution system 2,
a burner 14 provided with a conduit 15 for feeding an A2 stream of a gaseous fuel thereto and a conduit 16 for withdrawing an E stream of gases outgoing from the burner,
means 17 for separating gas streams and controlling their flowrate.

The burner 14 may be any burner known in the art.

Preferably, the burner 14 is a catalytic burner, which enables to further reduce electric power consumed by a compressor 8 by increasing mechanical power provided by an expander 9, improve its reliability and decrease a quantity of harmful emissions when the burner is operated.

The means 17 for separating gas streams and controlling their flowrate are any means known in the art, which enable to separate gas streams and control their flowrate; these may be, e.g., three-way cocks, valves, throttles, flaps, their combinations, etc.

The gaseous heat carrier recirculation system 5 may consist of one or more fans of different types, jet and other pumps, nozzles, valves, mixing units, confusors, diffusers, etc.

Preferably, hydrogen or synthesis gas is used as the gaseous fuel, and pure oxygen, atmospheric air, mixture of oxygen and water steam, or another mixture of oxygen and gases not involved in the electrochemical reaction is used as the oxygen-containing mixture.

The use of oxygen with water steam or another mixture of oxygen with gases not involved into the electrochemical reaction as the oxygen-containing mixture instead of air enables to reduce consumption of air in applications where access to air is limited while oxygen source is available, for example in a submarine or a spacecraft.

The C stream of gases effluent from the anode gas distribution system 3 and the D stream of gases effluent from the cathode gas distribution system 4 enter the burner 14 via the conduit 11 and the conduit 12, respectively.

The conduit 16 for withdrawing the E stream of gases outgoing from the burner is configured to feed the E stream of gases outgoing from the burner first to the expander 9 at which outlet the conduit 16 is divided into a conduit 18 for withdrawing an E1 stream and a conduit 19 for withdrawing an E2 stream.

The E1 stream is discharged to the atmosphere, and the E2 stream enters the gaseous heat carrier recirculation system 5.

The conduit 13 for withdrawing an F stream of gases effluent from the gaseous heat carrier distribution system 2 is divided into a conduit 20 for withdrawing an F1 stream and a conduit 21 for withdrawing an F2 stream.

The F1 stream is discharged to the atmosphere, and the F2 stream enters the gaseous heat carrier recirculation system 5 where it is mixed with the B2 oxygen-containing mixture stream and the E2 stream to produce a mixed gas stream that is fed to the gaseous heat carrier distribution system 2.

The air-cooled fuel cell system has a startup battery 22 for starting operation of the system.

The air-cooled fuel cell system works as follows.

The A1 gaseous fuel stream is fed to the anode gas distribution system 3, the B1 oxygen-containing mixture stream is fed to the cathode gas distribution system 4 by means of the compressor, and the B2 oxygen-containing mixture stream is fed to the gaseous heat carrier recirculation system 5.

The compressor is driven by the expander and the motor.

The motor may be electric motor or hydraulic motor or electro-hydraulic motor.

The C stream of gases effluent from the anode gas distribution system 3, the D stream of gases effluent from the cathode gas distribution system 4, and the F stream of gases effluent from the gaseous heat carrier distribution system 2 are withdrawn from the fuel cell stack 1.

As a result of an electrochemical reaction, an oxygen content is reduced and a steam content is increased in the D stream of gases effluent from the cathode gas distribution system 4.

As a result of mixing the C stream of gases effluent from the anode gas distribution system 3 and the D stream of gases effluent from the cathode gas distribution system 4, the gases effluent from the anode are further oxidized to stable compounds in the burner 14.

Oxidation to stable compounds means that a mixture may not start burning already and, moreover, explode, i.e. it is a safe mixture from the point of fire and explosion safety. Oxidation also provides temperature increase of the stream E.

The E stream of gases, which is heated, preferably, to 150-500° C. at the burner outlet, is fed to the expander 9 that drives the compressor 8 delivering the pressurized BI oxygen-containing mixture stream to the cathode gas distribution system 4, which enables to use heat of the E stream for driving the compressor 9, and, thus, reduce power inputs required for driving the compressor and improve the system operating efficiency.

After the expander 9, the E stream of gases outgoing from the burner is separated into two streams: E1 and E2.

The E1 stream is discharged to the atmosphere.

The E2 stream is fed to the gaseous heat carrier recirculation system 5.

The F stream of gases effluent from the gaseous heat carrier distribution system 2 is separated into two streams: F1 and F2.

The F1 stream is discharged to the atmosphere.

The F2 stream is fed to the gaseous heat carrier recirculation system 5 for mixing with the B2 stream and with the E2 stream and, then, the mixed stream is fed to the gaseous heat carrier distribution system 2.

A ratio between a volume flowrate of the E1 and E2 streams and the F1 and F2 streams is selected with due regard to a temperature of the B2 oxygen-containing mixture stream so as to achieve a preset temperature of the mixed stream consisting of a B2, F2 and E2 stream mixture entering the gaseous heat carrier distribution system 2.

In the recirculation system 5, a gas stream consisting of the F2, B2, E2 streams, entering the gaseous heat carrier distribution system 2, is stirred and additionally pressurized, which enables to produce a homogenous stream with a preset temperature and a pressure sufficient for passing through channels, recesses and hollows of the gaseous heat carrier distribution system 2 and transfer thermal energy efficiently, i.e. cool or heat, depending on a particular case, the components of the fuel cell stack.

FIG. 1 shows that the F2 stream is first mixed with the B2 stream to produce an F3 stream, and then the produced stream is fed at a high pressure for mixing with the E2 stream to produce an F4 stream fed to the gaseous heat carrier distribution system 2.

However, the order of mixing the F2, B2, E2 streams is not significant in principle, and various orders of mixing these streams are possible.

Mixing the F2 stream of gases effluent from the gaseous heat carrier distribution system 2, the B2 oxygen-containing mixture stream and the E2 stream of gases outgoing from the burner helps to condition, i.e. bring to a required temperature, the gaseous heat carrier and reduce its flowrate, which lowers requirements to capacity of means (fans/compressors) for delivering a pressurized gaseous heat carrier stream and, consequently, enables to use means having a smaller weight; this leads to a reduction in the fuel cell system weight, while preserving the possibility of performing effective thermal control of a fuel cell, thus enabling to use such a fuel cell in any climatic conditions.

Owing to the fact that the F2 stream of gases effluent from the gaseous heat carrier distribution system 2 is involved in producing a mixed stream that is fed to the gaseous heat carrier distribution system 2, the system according to Embodiment 1 may be efficiently used in the temperature difference between a fuel cell operating temperature and an ambient temperature from 60°° C. to 400° C., since a combination of the F2 stream (heated), the B2 stream (not heated), the E2 stream (heated) provides the possibility of widely controlling a temperature of the mixed stream used for heating or cooling the fuel cell stack components.

As opposed to conventional technical solutions, a gaseous heat carrier (e.g. air) in the fuel cell stack of this invention does not interact with a cathode gas and is not mixed therewith, since the gaseous heat carrier passes through the separate gaseous heat carrier distribution system, and a cathode gas passes through the separate cathode gas distribution system.

It is known that, in order to increase operating efficiency of a fuel cell, the anode and cathode gas pressure should be increased, but systems where the same air is directed both to the cathode and for cooling have limitations to a pressure of supplied air because of high flow rates required for cooling and, therefore, high power needed for compression of cooling air.

When feeding cooling air and air directed to the cathode separately, these limitations are removed and power inputs are reduced, since a feeding pressure of cooling air may be lower than that required for air directed to the cathode.

Separation of the streams for the electrochemical reaction (oxygen-containing mixture and gaseous fuel) and that for thermal control (gaseous heat carrier) enables to maintain their pressure and temperature independently, which provides efficient thermal control of a fuel cell and enables to use it in any climatic conditions and at any altitudes.

In order to preheat the fuel cell 1 from the “cold” condition to the operating condition in the ambient temperature range from −55° C. to +60° C. before starting the system operation, the step of preheating the fuel cell 1 to a preset temperature is conducted wherein the following processes are performed.

The B1 oxygen-containing mixture stream and the A2 gaseous fuel stream are fed to the burner 14, the pressurized BI stream being delivered by the compressor 8 driven by the expander 9 and the motor.

The E stream of gases outgoing from the burner 14 is fed to the expander 9 and, thereafter, the E stream is fed to the gaseous heat carrier distribution system 2.

The F stream of gases effluent from the gaseous heat carrier distribution system 2 is discharged to the atmosphere.

Upon exiting the burner, the E stream has an average temperature in the range from +50° C. to +400° C., which enables to preheat the fuel cell 1.

The step of preheating the fuel cell 1 enables to start operation of the fuel cell 1 and make system operation independent on ambient temperature, which positively affects its reliability and efficiency.

Preheating of ambient air may be required for efficient operation of the fuel cell at low temperatures of the atmosphere. This is especially important for mid-temperature (HTPEM FC, PAFC) and high-temperature fuel cells (MCFC, SOFC).

Feeding of hot air from the burner to the gaseous heat carrier distribution system of the fuel cell stack in the mode of fuel cell preheating enables to exclude an electric heater from the system, thus reducing consumption of electric power at start and decreasing the system weight due to excluding an additional weight of an electric battery and an electric heater.

Tests show that Embodiment 1 of the invention may be efficiently used at a temperature difference between a fuel cell operating temperature and an ambient temperature from 60° C. to 400° C., and the claimed embodiments of the air thermal control system according to this invention are 3-10 times lighter than a conventional liquid thermal control (cooling) system due to the exclusion of the heaviest components, i.e. a liquid heat carrier and a heat exchanger.

Further, the system according to this invention provides a great specific power of the fuel cell system as compared to conventional air cooling systems, since the latter work without compression of cathode air simultaneously used for cooling. In the proposed system, cathode air and cooling air streams are separated, which enables additionally compress a comparatively small stream of cathode air and achieve a great power of a fuel cell with minimal power inputs and minimal weight of a compressor unit (including a compressor, an expender, and a motor).

It was established during the tests that 2.5-times compression of cathode air (from 101 kPa to 250 kPa abs.) led to increase of fuel cell output power by 80-90%, i.e. by a factor of 1.8-1.9.

The use of an expander (turbo-expander) in combination with a catalytic burner, also referred to as anode tail gas oxidizer (ATO), and a higher operating temperature of mid-temperature fuel cells HTPEM FC also enables to significantly reduce power consumption of the compressor unit, Turbo Compressor Unit (TCU), as well as reduce a weight of its electric motor and inverter.

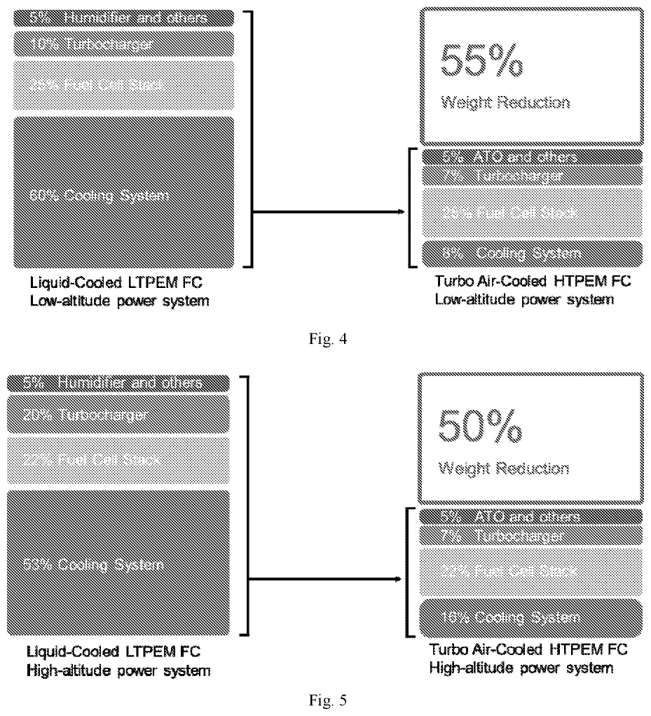

Thus, the use of this system alongside with replacement of low-temperature fuel cells (LTPEM FC) by mid-temperature HTPEM FC enables to reduce the system weight more than two times (see FIG. 4) and total power consumption for compression of cathode air and cooling from 12-16% to 5-8% of a total power produced by the fuel cell system.

### Embodiment 2

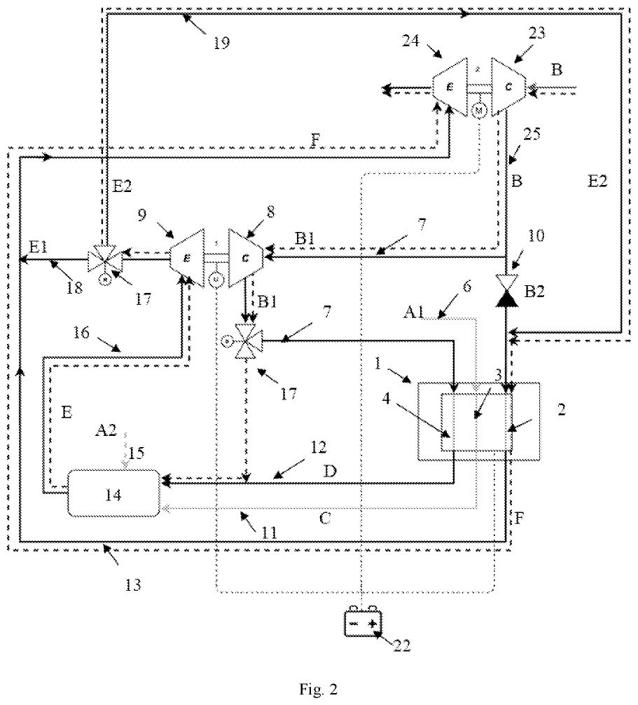

FIG. 2 shows the air-cooled fuel cell system according to Embodiment 2, which differs from the air-cooled fuel cell system according to Embodiment 1 in that the B and B2 oxygen-containing mixture streams are separated from the single total B oxygen-containing mixture stream delivered by the additional compressor 23; a gas heat carrier recirculation system is absent, and the F stream of gases effluent from the gaseous heat carrier distribution system 2 is fed to the additional expander 24 driving the additional compressor 23.

The air-cooled fuel cell system according to Embodiment 2 comprises the fuel cell stack 1 that comprises the gaseous heat carrier distribution system 2, the anode gas distribution system 3 and the cathode gas distribution system 4.

Further, the air-cooled fuel cell system comprises:
the conduit 6 for feeding the A1 gaseous fuel stream to the anode gas distribution system 3,
the conduit 25 for feeding the B oxygen-containing mixture stream, which is divided into the conduit 7 for feeding the B1 stream to the cathode gas distribution system 4 and the conduit 10 for feeding the B2 stream to the gaseous heat carrier distribution system 2,
the compressor 8 for delivering the pressurized B1 oxygen-containing mixture stream, which is configured to be driven by an expander 9 and the motor (indicated by a circled letter M),
an additional compressor 23 for delivering the pressurized B oxygen-containing mixture stream, which is configured to be driven by an additional expander 24 and the additional motor (indicated by a circled letter M),
the conduit 11 for withdrawing the C stream of gases effluent from the anode gas distribution system 3,
the conduit 12 for withdrawing the D stream of gases effluent from the cathode gas distribution system 4,
the conduit 13 for withdrawing the F stream of gases effluent from the gaseous heat carrier distribution system 2,
the burner 14 provided by the conduit 15 for feeding the A2 gaseous fuel stream thereto and the conduit 16 for withdrawing the E stream of gases outgoing from the burner,
the means 17 for separating gas streams and controlling their flowrate.

The burner 14 may be any burner known in the art.

Preferably, the burner 14 is a catalytic burner, which guarantees low NOx emission and high reliability.

The means 17 for separating gas streams and controlling their flowrate are any means known in the art, which enable to separate gas streams and control their flowrate; these may be, e.g., three-way cocks, valves, throttles, flaps, their combinations, etc.

Preferably, hydrogen or synthesis gas is used as the gaseous fuel, and atmospheric air, mixture of oxygen and water steam, or another mixture of oxygen and gases not involved in the electrochemical reaction is used as the oxygen-containing mixture.

The use of oxygen with water steam or another mixture of oxygen with gases not involved into the electrochemical reaction as the oxygen-containing mixture instead of air enables to reduce consumption of air in applications where access to air is limited while oxygen source is available, for example in a submarine or a spacecraft.

The C stream of gases effluent from the anode gas distribution system 3 and the D stream of gases effluent from the cathode gas distribution system 4 enter the burner 14 via the conduit 11 and the conduit 12, respectively.

The conduit 16 for withdrawing the E stream of gases outgoing from the burner is configured to feed the E stream of gases outgoing from the burner first to the expander 9 at which outlet the conduit 16 is divided into a conduit 18 for withdrawing an E1 stream and a conduit 19 for withdrawing an E2 stream.

The E1 stream enters the additional expander 24 and, then, is discharged to the atmosphere, and the E2 stream is mixed with the B2 stream to produce a mixed stream that is fed to the gaseous heat carrier distribution system 2.

The conduit 13 for withdrawing the F stream of gases effluent from the gaseous heat carrier distribution system 2 is configured so that the F stream enters the additional expander 24 and, then, is discharged to the atmosphere.

The air-cooled fuel cell system has a startup battery 22 for starting operation of the system.

The air-cooled fuel cell system works as follows.

The A1 gaseous fuel stream is fed to the anode gas distribution system 3.

The B oxygen-containing mixture stream is fed to the additional compressor 23 driven by the additional expander 24 and the additional motor (not shown), and then the B stream is separated into the B1 stream and the B2 stream.

The B1 stream is fed to the cathode gas distribution system 4, this pressurized BI stream is delivered by the compressor 8 driven by the expander 9 and the motor (indicated by a circled letter M).

The B2 stream is fed to the gaseous heat carrier distribution system 2.

The C stream of gases effluent from the anode gas distribution system 3, the D stream of gases effluent from the cathode gas distribution system 4 and the F stream of gases effluent from the gaseous heat carrier distribution system 2 are withdrawn from the fuel cell stack.

The C stream and the D stream are fed to the burner.

When heated, preferably, to 150-500° C., the E stream of gases outgoing from the burner is fed to the expander 9 driving the compressor 8 delivering the pressurized B1 oxygen-containing mixture stream to the cathode gas distribution system 4, which enables to use heat of the E stream for driving the compressor 9, and, thus, reduce power inputs required for driving the compressor and improve the system operating efficiency.

After the expander 9, the E stream of gases outgoing from the burner is separated into two streams: E1 and E2.

The E1 stream is fed to the additional expander 24 with subsequent discharge to the atmosphere, which enables to use heat of the E1 stream for driving the additional compressor 23, and, thus, reduce power inputs required for driving the compressor and improve the system operating efficiency.

The E2 stream is mixed with the B2 stream to produce a mixed stream that is fed to the gaseous heat carrier distribution system 2.

The F stream of gases effluent from the gaseous heat carrier distribution system 2 is fed to the additional expander 24 with subsequent discharge to the atmosphere, which enables to use heat of the F stream for driving the additional compressor 23, and, thus, reduce power inputs required for driving the compressor and improve the system operating efficiency.

A ratio between a volume flowrate of the E1 and E2 streams is selected with due regard to a temperature of the B2 oxygen-containing mixture stream so as to achieve a preset temperature of the mixed stream consisting of a B2 and E2 stream mixture entering the gaseous heat carrier distribution system 2.

Mixing the B2 oxygen-containing mixture stream and the E2 stream of gases effluent from the burner helps to condition, i.e. bring to a required temperature, the gaseous heat carrier and reduce its flowrate, which lowers requirements to capacity of means (fans/compressors) for delivering a pressurized gaseous heat carrier stream and, consequently, enables to use means having a smaller weight; this leads to a reduction in the fuel cell system weight, while preserving the possibility of performing effective thermal control of a fuel cell.

In the system according to Embodiment 2, the F stream of gases effluent from the gaseous heat carrier distribution system 2 is not involved in producing a mixed stream fed to the gaseous heat carrier distribution system 2, and, instead of it, thermal energy of the F stream together with thermal energy of the E1 stream is used for driving the additional compressor 23 and providing additional pressure to the B oxygen-containing mixture stream, which pressure is transferred to the B1 and B2 streams fed to the cathode gas distribution system 4 and to the gaseous heat carrier distribution system 2, respectively, which leads to acceleration of the chemical reaction in the fuel cell stack and improvement of its operating efficiency; this enables to use the system at high altitudes—from 15,000 ft (4.5 km) to 50,000 ft (15 km).

However, the system according to Embodiment 2, in comparison with Embodiment 1, has limited possibilities to control a temperature of the mixed stream used for heating or cooling the fuel cell stack components due to the fact that the F stream of gases effluent from the gaseous heat carrier distribution system 2 is not involved into producing the mixed stream fed to the gaseous heat carrier distribution system 2.

In all other aspects, the system according to Embodiment 2 has the same advantages as the system according to Embodiment 1.

In order to preheat the fuel cell 1 from the “cold” condition to the operating condition in the ambient temperature range from −55° C. to +60° C. before starting the system operation, the step of preheating the fuel cell 1 to a preset temperature is conducted wherein the following processes are performed.

The B oxygen-containing mixture stream and the A2 gaseous fuel stream are fed to the burner 14, the pressurized B stream being delivered by the compressor 8 driven by the expander 9 and the motor as well as by the additional compressor 23 driven by the additional expander 24 and the additional motor.

The E stream of gases outgoing from the burner 14 is fed to the expander 9, and thereafter the E stream is fed to the gaseous heat carrier distribution system 2.

The F stream of gases effluent from the gaseous heat carrier distribution system 2 is fed to the additional expander 24 with subsequent discharge to the atmosphere, which enables use heat of the F stream for driving the additional compressor 23, and, thus, reduce power inputs required for driving the compressor and improve the system operating efficiency.

Upon exiting from the burner, the E stream has an average temperature in the range from +50° C. to +400° C., which enables to preheat the fuel cell 1.

The step of preheating the fuel cell 1 enables to start operation of the fuel cell 1 and make system operation independent of ambient temperature, which positively affects its reliability and efficiency.

Tests show that the invention according to Embodiment 2 may be efficiently used for starting from conventional altitudes from 0 to 5,000 ft (1.5 km) and further operating an aircraft in a cruising mode in stable ambient conditions (temperature and pressure) at high altitudes from 15,000 ft (4.5 km) to 50,000 ft (15 km), and the system according to this invention is 2-3 times lighter than a conventional liquid thermal control (cooling) system due to the exclusion of the heaviest components, i.e. a liquid heat carrier and a heat exchanger.

Further, the system according to this invention provides a great specific power of the fuel cell stack as compared to conventional air cooling systems, since the latter work without compression of cathode air and air fed for cooling.

The system according to this invention may provide compression of both cooling air and cathode air, and with different compression ratios. Compression of cooling air, in particular by means of the additional compressor, leads to improvement in heat exchange efficiency between air and the fuel cell stack and to decreasing the system volume and power consumed for cooling.

It was established during the tests that 2.5-times compression of cathode air (from 101 kPa to 250 kPa abs.) led to increase of fuel cell output power by 80-90%, i.e. by a factor of 1.8-1.9. The overall compression ratio of two compressors at high altitude can achieve 4-7 that provides increase in power output more than in 2.5 times.

The use of an expander (turbo-expander) in combination with a catalytic burner, also referred to as anode tail gas oxidizer (ATO), and a higher operating temperature of mid-temperature fuel cells HTPEM FC also enables to significantly reduce power consumption of the compressor unit, Turbo Compressor Unit (TCU), as well as reduce a weight of its electric motor and inverter.

Thus, the use of this system alongside with replacement of low-temperature fuel cells (LTPEM FC) by mid-temperature HTPEM FC enables to reduce the system weight more than two times (see FIG. 5) and total power consumption for compression of cathode air and cooling from 12-16% to 5-8% of a total power produced by the fuel cell system.

### Embodiment 3

The system according to Embodiment 3 of this invention combines all advantages of the system according to Embodiment 1 and the system according to Embodiment 2.

The availability of the gaseous heat carrier recirculation system 5 in Embodiment 3 of the invention enables to control a temperature of the mixed stream used for heating or cooling the fuel cell stack components within a wide range, which enables to efficiently use the system when a temperature difference between the fuel cell operating temperature and an ambient temperature is from 60° C. to 400° C.

The use of thermal energy of the F1 stream of gases effluent from the gaseous heat carrier distribution system 2 together with thermal energy of the E1 stream of gases outgoing from the burner for driving the additional compressor 23 and increasing a pressure of the B oxygen-containing mixture stream which is transferred to the B1 and B2 streams fed to the cathode gas distribution system 4 and to the gaseous heat carrier distribution system 2, respectively, leads to acceleration of the chemical reaction in the fuel cell stack and improvement in its operation: this enables to use this system at high altitudes—from 15,000 ft (4.5 km) to 50,000 ft (15 km).

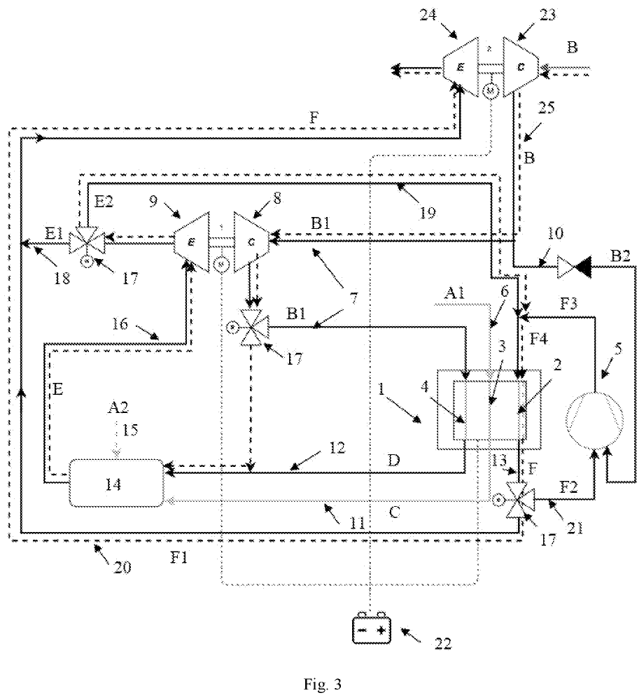

FIG. 3 shows the air-cooled fuel cell system comprising the fuel cell stack 1.

The fuel cell stack 1 comprises the gaseous heat carrier distribution system 2, the anode gas distribution system 3 and the cathode gas distribution system 4.

The air-cooled fuel cell system further comprises the gaseous heat carrier recirculation system 5 connected to the gaseous heat carrier distribution system 2 and intended for mixing a gas stream entering the gaseous heat carrier distribution system 2 and providing additional pressure thereto.

Further, the air-cooled fuel cell system comprises:
the conduit 6 for feeding the A1 gaseous fuel stream to the anode gas distribution system 3,
the conduit 25 for feeding the B oxygen-containing mixture stream, which is divided into the conduit 7 for feeding the B1 stream to the cathode gas distribution system 4 and the conduit for feeding the B2 stream to the gaseous heat carrier distribution system 2,
the compressor 8 for delivering the pressurized BI oxygen-containing mixture stream, which is configured to be driven by the expander 9 and the motor (indicated by a circled letter M),
the additional compressor 23 for delivering the pressurized B oxygen-containing mixture stream, which is configured to be driven by the additional expander 24 and the additional motor (indicated by a circled letter M),
the conduit 11 for withdrawing the C stream of gases effluent from the anode gas distribution system 3,
the conduit 12 for withdrawing the D stream of gases effluent from the cathode gas distribution system 4,
the conduit 13 for withdrawing the F stream of gases effluent from the gaseous heat carrier distribution system 2,
the burner 14 provided with the conduit 15 for feeding the A2 gaseous fuel stream thereto and the conduit 16 for withdrawing the E stream of gases outgoing from the burner,
the means 17 for separating gas streams and controlling their flowrate.

The burner 14 may be any burner known in the art.

Preferably, the burner 14 is a catalytic burner, which guarantees low NOₓ emission and high reliability.

The means 17 for separating gas streams and controlling their flowrate are any means known in the art, which enable to separate gas streams and control their flowrate: these may be, e.g., three-way cocks, valves, throttles, flaps, their combinations, etc.

The gaseous heat carrier recirculation system 5 may consist of one or more fans of different types, jet and other pumps, nozzles, valves, mixing units, confusors, diffusers, etc.

Preferably, hydrogen or synthesis gas is used as the gaseous fuel, and atmospheric air, mixture of oxygen and water steam, or another mixture of oxygen and gases not involved in the electrochemical reaction is used as the oxygen-containing mixture.

The use of oxygen with water steam or another mixture of oxygen with gases not involved into the electrochemical reaction as the oxygen-containing mixture instead of air enables to reduce consumption of air in applications, where access to air is limited while oxygen source is available, for example in a submarine or a spacecraft.

The C stream of gases effluent from the anode gas distribution system 3 and the D stream of gases effluent from the cathode gas distribution system 4 enter the burner 14 via the conduit 11 and the conduit 12, respectively.

The conduit 16 for withdrawing the E stream of gases outgoing from the burner is configured to feed the E stream of gases outgoing from the burner first to the expander 9 at which outlet the conduit 16 is divided into the conduit 18 for withdrawing the El stream and the conduit 19 for withdrawing the E2 stream.

The E1 stream enters to the additional expander 24 and then is discharged to the atmosphere, and the E2 stream is mixed with the B2 and F2 streams to produce a mixed stream that is fed to the gaseous heat carrier distribution system 2.

The conduit 13 for withdrawing the F stream of gases effluent from the gaseous heat carrier distribution system 2 is divided into the conduit 20 for withdrawing the FI stream and the conduit 21 for withdrawing the F2 stream.

The F1 stream is fed to the additional expander 24 with subsequent discharge to the atmosphere, which enables to use heat of the F1 stream for driving the additional compressor 23 and, thus, reduce power inputs required for driving the compressor and improve the system operating efficiency.

The F2 stream enters the gaseous heat carrier recirculation system 5 where it is mixed with the B2 oxygen-containing mixture stream and the E2 stream to produce a mixed gas stream that is fed to the gaseous heat carrier distribution system 2.

The air-cooled fuel cell system has a startup battery 22 for staring the system operation. The air-cooled fuel cell system works as follows.

The A1 gaseous fuel stream is fed to the anode gas distribution system 3.

The B oxygen-containing mixture stream is fed to the additional compressor 23 driven by the additional expander 24 and the additional motor (not shown), and then the B stream is separated into the B1 stream and the B2 stream.

The B1 stream is fed to the cathode gas distribution system 4, the pressurized B1 stream being delivered by the compressor 8 driven by the expander 9 and the motor (indicated by a circled letter M).

The motor and the additional motor may be electric motors or hydraulic motors or electro-hydraulic motors.

The B2 stream is fed to the gaseous heat carrier recirculation system 5.

The C stream of gases effluent from the anode gas distribution system 3, the D stream of gases effluent from the cathode gas distribution system 4 and the F stream of gases effluent from the gaseous heat carrier distribution system 2 are withdrawn from the fuel cell stack.

The C stream and the D stream are fed to the burner.

The C stream of gases effluent from the anode gas distribution system 3, the D stream of gases effluent from the cathode gas distribution system 4 and the F stream of gases effluent from the gaseous heat carrier distribution system 2 are withdrawn from the fuel cell stack.

The electrochemical reaction results in decreasing an oxygen content and increasing a water steam content of the D stream of gases effluent from the cathode gas distribution system 4.

As the result of mixing the C stream of gases effluent from the anode gas distribution system 3 and the D stream of gases effluent from the cathode gas distribution system 4, the gases effluent from the anode are further oxidized to stable compounds in the burner 14.

When heated, preferably, to 150-500° C., the E stream of gases outgoing from the burner is fed to the expander 9 driving the compressor 8 delivering the pressurized BI oxygen-containing mixture stream to the cathode gas distribution system 4, which enables to use heat of the E stream for driving the compressor 9, and, thus, reduce power inputs required for driving the compressor and improve the system operating efficiency.

After the expander 9, the E stream of gases outgoing from the burner is separated into two streams: E1 and E2.

The E1 stream is fed to the additional expander 24 with subsequent discharge to the atmosphere, which enables to use heat of the El stream for driving the additional compressor 23, and, thus, reduce power inputs required for driving the compressor and improve the system operating efficiency.

The E2 stream is fed to the gaseous heat carrier recirculation system 5.

The F stream of gases effluent from the gaseous heat carrier distribution system 2 is separated into two streams: F1 and F2.

The F1 stream is fed to the additional expander 24 with subsequent discharge to the atmosphere, which enables to use heat of the F stream for driving the additional compressor 23, and, thus, reduce power inputs required for driving the compressor and improve the system operating efficiency.

The F2 stream is fed to the gaseous heat carrier recirculation system 5 for mixing with the B2 stream and with the E2 stream and, then, a mixed stream is fed to the gaseous heat carrier distribution system 2.

A ratio between a volume flowrate of the E1 and E2 streams and the F1 and F2 streams is selected with due regard to a temperature of the B2 oxygen-containing mixture stream so as to achieve a preset temperature of the mixed stream consisting of a B2, F2 and E2 stream mixture entering the gaseous heat carrier distribution system 2.

In the recirculation system 5, a gas stream consisting of the F2, B2, E2 streams, as entering the gaseous heat carrier distribution system 2, is stirred and additionally pressurized, which enables to produce a homogenous stream with a preset temperature and a pressure sufficient for passing through channels, recesses and hollows of the gaseous heat carrier distribution system 2 and transfer thermal energy efficiently, i.e. cool or heat, depending on a particular case, the components of the fuel cell stack.

FIG. 3 shows that the F2 stream is first mixed with the B2 stream to produce the F3 stream, and then the pressurized produced stream is fed for mixing with the E2 stream to produce the F4 mixed stream fed to the gaseous heat carrier distribution system 2.

However, the order of mixing the F2, B2, E2 streams is not significant in principle, and various orders of mixing these streams are possible.

The system according to Embodiment 3 of the invention has all advantages described for the system according to Embodiment 1 and the system according to Embodiment 2.

In order to preheat the fuel cell 1 from the “cold” condition to the operating condition in the ambient temperature range from −55° C. to +60° C. before starting the system operation, the step of preheating the fuel cell 1 to a preset temperature is conducted wherein the following processes are performed.

The B oxygen-containing mixture stream and the A2 gaseous fuel stream are fed to the burner 14, the pressurized B stream being delivered by the compressor 8 driven by the expander 9 and the motor as well as by the additional compressor 23 driven by the additional expander 24 and the additional motor.

The E stream of gases outgoing from the burner 14 is fed to the expander 9 and, thereafter, the E stream is fed to the gaseous heat carrier distribution system 2.

The F stream of gases effluent from the gaseous heat carrier distribution system 2 is fed to the additional expander 24 with subsequent discharge to the atmosphere, which enables to use heat of the F stream for driving the additional compressor 23 and, thus, reduce power inputs required for driving the compressor and improve the system operating efficiency.

Upon exiting the burner, the E stream has an average temperature in the range from +50° C. to +400° C., which enables to preheat the fuel cell 1.

The step of preheating the fuel cell 1 enables to start operation of the fuel cell 1 and make system operation independent of ambient temperature, which positively affects its reliability and efficiency.

Preheating in the system according to Embodiment 3 of the invention enables to obtain all advantages described for the system according to Embodiment 1 and the system according to Embodiment 2.

Tests show that the invention according to Embodiment 3 may be efficiently used at a temperature difference between a fuel cell operating temperature and an ambient temperature from 60° C. to 400° C. and at any altitudes in the range from 0 to 50,000 ft (15 km), and the system according to this invention is 2-5 times lighter than a conventional liquid thermal control (cooling) system due to the exclusion of the heaviest components, i.e. a liquid heat carrier and a heat exchanger.

Further, the system according to this invention provides a great specific power of the fuel cell stack as compared to conventional air cooling systems, since the latter work without compression of cathode air and air fed for cooling.

The system according to this invention may provide compression of both cooling air and cathode air, and with different compression ratios. Compression of cooling air, in particular by means of the additional compressor, leads to improvement in heat exchange efficiency between air and the fuel cell stack and to decreasing the system volume and power consumed for cooling.

It was established during the tests that 2.5-times compression of cathode air (from 101 kPa to 250 kPa abs.) led to increase of fuel cell output power by 80-90%, i.e. by a factor of 1.8-1.9. The overall compression ratio of two compressors at high altitude can achieve 4-7 that provides increase in power output more than in 2.5 times.

The use of an expander (turbo-expander) in combination with a catalytic burner, in particular an anode tail gas oxidizer (ATO), and a higher operating temperature of mid-temperature fuel cells HTPEM FC also enables to significantly reduce power consumption of the compressor unit, Turbo Compressor Unit (TCU), as well as reduce a weight of its electric motor and inverter.

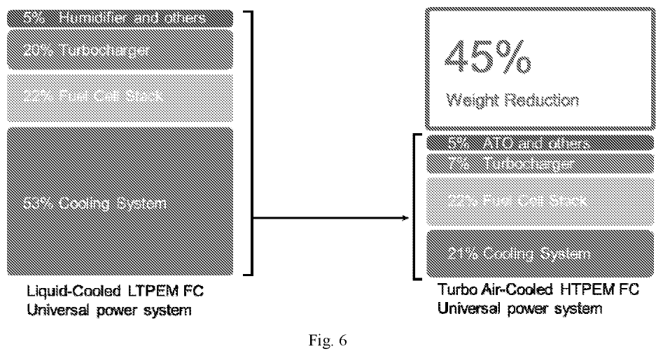

Thus, the use of this system alongside with replacement of low-temperature fuel cells (LTPEM FC) by mid-temperature HTPEM FC enables to reduce the system weight more than two times (see FIG. 6) and total power consumption for compression of cathode air and cooling from 12-16% to 5-8% of a total power produced by the fuel cell system.

The described embodiments are provided only in the illustrative purposes. A person skilled in the art will appreciate that other embodiments are also possible, but without changing the essence of the invention.

1.-15. (canceled)

16. A method comprising:
providing an air-cooled fuel cell system comprising:
at least one fuel cell stack comprising a gaseous heat carrier distribution system, an anode gas distribution system, and a cathode gas distribution system;
a burner;
an expander, a motor, and a compressor, wherein the compressor is driven by the expander and the motor;
a gaseous heat carrier recirculation system connected to the gaseous heat carrier distribution system, and
one or more valves configured to separate one or more gases;
feeding a gaseous fuel stream to the anode gas distribution system;
withdrawing, from the at least one fuel cell stack, anode gases effluent from the anode gas distribution system, cathode gases effluent from the cathode gas distribution system, and distribution gases effluent from the gaseous heat carrier distribution system;
feeding the anode gases and the cathode gases to the burner;
withdrawing, from the burner, a stream of output burner gases;
feeding the stream of output burner gases to the expander;
withdrawing, from the expander, a stream of expander gases;
separating, using the one or more valves, the expander gases into a first stream of expander gases and a second stream of expander gases, and
separating, using the one or more valves, the distribution gases into a first stream of distribution gases and a second stream of distribution gases.

17. The method of claim 16, further comprising:
feeding an oxygen-containing mixture stream to the compressor to obtain a pressurized stream,
wherein the oxygen-containing mixture stream comprises at least one of a pure oxygen, an atmospheric air, a mixture of oxygen and a water steam, or another mixture of oxygen and gases not involved in an electrochemical reaction, and
feeding the pressurized stream to the cathode gas distribution system.

18. The method of claim 16, further comprising:
feeding an oxygen-containing mixture stream to the gaseous heat carrier recirculation system, wherein the oxygen-containing mixture stream comprises at least one of a pure oxygen, an atmospheric air, a mixture of oxygen and a water steam, or another mixture of oxygen and gases not involved in an electrochemical reaction;
mixing, using the gaseous heat carrier recirculation system, the second stream of expander gases, the second stream of distribution gases, and the oxygen-containing mixture stream to produce a mixed stream, and
feeding the mixed stream to the gaseous heat carrier distribution system.

19. The method of claim 16, further comprising:
discharging the first stream of expander gases and the first stream of distribution gases to an atmosphere.

20. The method of claim 16, wherein the air-cooled fuel cell system further comprises:
an additional expander, an additional motor, and an additional compressor, wherein the additional compressor is driven by the additional expander and the additional motor.

21. The method of claim 20, further comprising:
feeding an oxygen-containing mixture stream to the additional compressor,
wherein the oxygen-containing mixture stream comprises at least one of a pure oxygen, an atmospheric air, a mixture of oxygen and a water steam, or another mixture of oxygen and gases not involved in an electrochemical reaction;
separating the oxygen-containing mixture stream into a first pressurized stream and a second pressurized stream;
feeding the first pressurized stream to the compressor and subsequently to the cathode gas distribution system, and
feeding the second pressurized stream to the gaseous heat carrier recirculation system.

22. The method of claim 21, further comprising:
mixing, using the gaseous heat carrier recirculation system, the second stream of expander gases, the second stream of distribution gases, and the second pressurized stream to produce a mixed stream, and
feeding the mixed stream to the gaseous heat carrier distribution system.

23. The method of claim 20, further comprising:
mixing the first stream of expander gases and the first stream of distribution gases to obtain a mixture, and
feeding the mixture to the additional expander with a subsequent discharge to an atmosphere.

24. The method of claim 16,
wherein the gaseous heat carrier recirculation system provides additional pressure to a mixed stream,
wherein the one or more valves are configured to control a flowrate of the one or more gases.

25. The method of claim 16, further comprising:
preheating the at least one fuel cell stack to a preset temperature, wherein preheating the at least one fuel cell stack comprises:
feeding an oxygen-containing mixture stream to the compressor to obtain a preheating pressurized stream,
wherein the oxygen-containing mixture stream comprises at least one of a pure oxygen, an atmospheric air, a mixture of oxygen and a water steam, or another mixture of oxygen and gases not involved in an electrochemical reaction;
feeding the preheating pressurized stream and a preheating gaseous fuel stream to the burner;
withdrawing, from the burner, a preheating stream of output burner gases;
feeding the preheating stream of output burner gases to the expander;
withdrawing, from the expander, a preheating stream of expander gases;
feeding the preheating stream of expander gases to the gaseous heat carrier distribution system, and
discharging a preheating stream of distribution gases effluent from the gaseous heat carrier distribution system to an atmosphere.

26. The method of claim 20, further comprising:
preheating the at least one fuel cell stack to a preset temperature, wherein preheating the at least one fuel cell stack comprises:
feeding an oxygen-containing mixture stream to the additional compressor to obtain an additional preheating pressurized stream,
wherein the oxygen-containing mixture stream comprises at least one of a pure oxygen, an atmospheric air, a mixture of oxygen and a water steam, or another mixture of oxygen and gases not involved in an electrochemical reaction;
feeding the additional preheating pressurized stream to the compressor to obtain a preheating pressurized stream;
feeding the preheating pressurized stream and a preheating gaseous fuel stream to the burner;
withdrawing, from the burner, a preheating stream of output burner gases;
feeding the preheating stream of output burner gases to the expander;
withdrawing, from the expander, a preheating stream of expander gases;
feeding the preheating stream of expander gases to the gaseous heat carrier distribution system;
feeding a preheating stream of distribution gases effluent from the gaseous heat carrier distribution system to the additional expander;
withdrawing, from the additional expander, a preheating stream of additional expander gases, and
discharging the preheating stream of additional expander gases to an atmosphere.

27. The method according to claim 16, wherein the gaseous fuel stream comprises at least one of hydrogen and a synthesis gas.

28. The method according to claim 16, wherein the burner is a catalytic burner.

29. A method comprising:
providing an air-cooled fuel cell system comprising:
at least one fuel cell stack comprising a gaseous heat carrier distribution system, an anode gas distribution system, and a cathode gas distribution system;
a burner;
an expander, a motor, and a compressor, wherein the compressor is driven by the expander and the motor;
an additional expander, an additional motor, and an additional compressor, wherein the additional compressor is driven by the additional expander and the additional motor, and
one or more valves configured to separate one or more gases;
feeding a gaseous fuel stream to the anode gas distribution system;
withdrawing, from the at least one fuel cell stack, anode gases effluent from the anode gas distribution system, cathode gases effluent from the cathode gas distribution system, and distribution gases effluent from the gaseous heat carrier distribution system;
feeding the anode gases and the cathode gases to the burner;
withdrawing, from the burner, a stream of output burner gases;
feeding the stream of output burner gases to the expander;
withdrawing, from the expander, a stream of expander gases, and
separating, using the one or more valves, the expander gases into a first stream of expander gases and a second stream of expander gases.

30. The method of claim 29, further comprising:
feeding an oxygen-containing mixture stream to the additional compressor,
wherein the oxygen-containing mixture stream comprises at least one of a pure oxygen, an atmospheric air, a mixture of oxygen and a water steam, or another mixture of oxygen and gases not involved in an electrochemical reaction;
separating the oxygen-containing mixture stream into a first pressurized stream and a second pressurized stream;
feeding the first pressurized stream to the compressor and subsequently to the cathode gas distribution system, and
feeding the second pressurized stream to the gaseous heat carrier distribution system.

31. The method of claim 29, further comprising:
mixing the first stream of expander gases and the distribution gases to obtain a mixture, and
feeding the mixture to the additional expander with a subsequent discharge to an atmosphere.

32. The method of claim 30, further comprising:
mixing the second stream of expander gases and the second pressurized stream to produce a mixed stream, and
feeding the mixed stream to the gaseous heat carrier distribution system.

33. The method of claim 29, further comprising:
preheating the at least one fuel cell stack to a preset temperature, wherein preheating the at least one fuel cell stack comprises:
feeding an oxygen-containing mixture stream to the additional compressor to obtain an additional preheating pressurized stream,
wherein the oxygen-containing mixture stream comprises at least one of a pure oxygen, an atmospheric air, a mixture of oxygen and a water steam, or another mixture of oxygen and gases not involved in an electrochemical reaction;
feeding the additional preheating pressurized stream to the compressor to obtain a preheating pressurized stream;
feeding the preheating pressurized stream and a preheating gaseous fuel stream to the burner;
withdrawing, from the burner, a preheating stream of output burner gases;
feeding the preheating stream of output burner gases to the expander;
withdrawing, from the expander, a preheating stream of expander gases;
feeding the preheating stream of expander gases to the gaseous heat carrier distribution system;
feeding a preheating stream of distribution gases effluent from the gaseous heat carrier distribution system to the additional expander;
withdrawing, from the additional expander, a preheating stream of additional expander gases, and
discharging the preheating stream of additional expander gases to an atmosphere.

34. The method according to claim 29, wherein the gaseous fuel stream comprises at least one of hydrogen or a synthesis gas.

35. The method according to claim 29, wherein the burner is a catalytic burner.
